(19) United States
(12) Patent Application Publication
(10) Pub. No.: US 2013/0231437 A1
(43) Pub. Date: Sep. 5, 2013

(54) Thermoplastic Resin Composition and Molded Products Thereof

(71) Applicant: CHEIL INDUSTRIES INC., Gumi-si (KR)

(72) Inventors: Jin Kyung CHO, Uiwang-si (KR); Do Hoon CHANG, Uiwang-si (KR); Jin Young HUH, Uiwang-si (KR); Ywan Hee LEE, Uiwang-si (KR); Doo Han HA, Uiwang-si (KR)

(73) Assignee: Cheil Industries Inc., Gumi-si (KR)

(21) Appl. No.: 13/866,146

(22) Filed: Apr. 19, 2013

Related U.S. Application Data
(63) Continuation-in-part of application No. PCT/KR2010/009537, filed on Dec. 29, 2010.

(30) Foreign Application Priority Data
Oct. 20, 2010 (KR) 10-2010-0102607

(51) Int. Cl. C08K 7/14

(52) U.S. Cl. CPC C08K 7/14
USPC 524/494; 524/508

(57) ABSTRACT

The present invention relates to a thermoplastic resin composition, comprising: a base resin comprising (A) a polyphenylene ether resin and (B) an aromatic vinyl-based resin, and (C) glass fibers, wherein the (C) glass fibers include (C1) chopped glass fibers and (C2) milled glass fibers.

### CROSS-REFERENCE TO RELATED APPLICATIONS

This application is a continuation-in-part of International Application No. PCT/KR2010/009537 filed on Dec. 29, 2010, pending, which designates the U.S., published as WO 2012/053700, and is incorporated herein by reference in its entirety, and claims priority therefrom under 35 USC Section 120. This application also claims priority under 35 USC Section 119 to and the benefit of Korean Patent Application No. 10-2010-0102607 filed on Oct. 20, 2010, the entire disclosure of which is incorporated herein by reference.

### FIELD OF THE INVENTION

The present invention relates to thermoplastic resin compositions and molded products thereof.

### BACKGROUND OF THE INVENTION

Generally, polyphenylene ether (PPE) or polyphenylene oxide resins have excellent heat resistance and mechanical strength and provide outstanding dimensional stability to products when processed. However, due to difficulty in processing these resins alone, these resins are generally blended with polystyrene resins or rubber reinforced polystyrene resins having good compatibility when used in the production of interior and exterior materials of electronic products.

In the case of blending PPE resins with polystyrene resins in order to improve flowability, there is a problem of reduction in impact strength, and glass fibers (GF) are added to compensate for such strength reduction. However, despite strength improvement, glass fibers can provide adverse effects on dimensional stability and processability due to physical properties thereof.

Japanese Patent Laid-Open publication No. 2008-024889 discloses the use of reinforcing fillers together with fluorine resins. Japanese Patent Laid-Open publication No. 2008-280532 discloses a method of limiting a molecular weight of PPE and the use of inorganic fillers subjected to surface treatment with silane. Japanese Patent Laid-Open publication No. 2006-188628 discloses a method of limiting the molecular weight of polyphenylene ether and the use of inorganic fillers together with glass fibers. Further, Japanese Patent Laid-Open publication No. 2005-290123 discloses a method of adding a polyamide resin. However, these methods have limits in improving dimensional stability, processability, heat resistance, flowability, and the like.

Specifically, thermoplastic resins for automobile ignition coils are required to have excellent strength, heat resistance, appearance, and dimensional stability. Therefore, there is a need for a polyphenylene ether thermoplastic resin having an excellent balance of physical properties, such as processability, strength, heat resistance, flowability, appearance, dimensional stability, and the like.

### SUMMARY OF THE INVENTION

The present invention relates to a thermoplastic resin composition that can have excellent flowability, heat resistance, mechanical strength, dimensional stability, and/or appearance by employing chopped glass fibers together with milled glass fibers, and molded products thereof. Specifically, the present invention can provide a thermoplastic resin composition capable of preventing flowability reduction, which is a drawback of polyphenylene ether resin as well as limitation of GF reinforcing materials, while achieving suppression of post-molding distortion, and good appearance.

The present invention can also provide a thermoplastic resin composition that can have excellent properties in terms of flowability, heat resistance, mechanical strength, dimensional stability and/or appearance, and can be suitable for materials for automobile ignition coils.

The present invention further provides a molded product that can have excellent flowability, heat resistance, strength, dimensional stability, and/or appearance.

The present invention is not limited to the aforementioned aspects, and other aspects, objects, features and advantages of the present invention will be clearly understood from the following description by those skilled in the art.

The thermoplastic resin composition includes: a base resin comprising (A) a polyphenylene ether resin and (B) an aromatic vinyl-based resin, and (C) glass fibers, wherein the (C) glass fibers include (C1) chopped glass fibers and (C2) milled glass fibers.

In one embodiment, the (C1) chopped glass fibers may have a length of about 1 mm or more. In one embodiment, the (C2) milled glass fibers may have a length from about 1 μm to about 999 μm, for example, the (C2) milled glass fibers may have a length from about 10 μm to about 100 μm.

In one embodiment, the milled glass fibers may be present in an amount of about 10 wt % to about 95 wt % based on the total weight of the (C) glass fibers.

The (C) glass fibers may be present in an amount of about 5 wt % to about 50 wt % based on the total weight (100 wt %) of the resin composition.

Further, the base resin may include about 45 wt % to about 90 wt % of the (A) polyphenylene ether resin.

Examples of the (B) aromatic vinyl-based resin may include without limitation polystyrene (PS), high impact polystyrene (HIPS), acrylonitrile-butadiene-styrene copolymer resin (ABS), acrylonitrile-styrene copolymer resin (SAN), acrylonitrile-styrene-acrylate copolymer resin (ASA), and the like. These resins may be used alone or in combination of two or more thereof.

The resin composition may further include one or more additives, such as flame retardants, plasticizers, coupling agents, heat stabilizers, light stabilizers, inorganic fillers, releasing agents, dispersing agents, anti-dripping agents, weather-proofing stabilizers, and the like. The additives may be used alone or in combination of two or more thereof.

In one embodiment, the resin composition may have a flexural modulus of about 40,000 kgfcm² or more as measured at ⅛ inch thickness in accordance with ASTM D790, a flexural strength of about 1,000 kgfcm² or more as measured at ⅛ inch thickness in accordance with ASTM D790, a heat distortion temperature (HDT) of about 140° C. or more under a load of 18.56 kgf/cm² in accordance with ASTM D648, and a melt index (MI) of about 12 g/10 min or more in accordance with ASTM D1238 (300° C., 5 kg).

The present invention also relates to a molded product using the composition. The molded product may have a structure in which the (C1) chopped glass fibers and (C2) milled glass fibers are dispersed in a base resin including (A) a polyphenylene ether resin and (B) an aromatic vinyl-based resin.

The thermoplastic composition of the present invention can have an excellent balance between physical properties including strength, heat resistance, flowability, appearance, dimensional stability, and the like, and thus can be advantageously used for automobile ignition coils.

The thermoplastic resin composition is also capable of preventing flowability reduction, which is a drawback of polyphenylene ether resin as well as limitation of GF reinforcing materials, while achieving suppression of post-molding distortion, and good appearance.

The present invention also provides a molded product using the same.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A thermoplastic resin composition of the present invention includes: a base resin including (A) a polyphenylene ether resin and (B) an aromatic vinyl-based resin, and (C) glass fibers, wherein the (C) glass fibers include (C1) chopped glass fibers and (C2) milled glass fibers.

The thermoplastic resin composition may include the base resin including (A) polyphenylene ether resin and (B) an aromatic vinyl-based resin in an amount of about 50 wt % to about 95 wt %, based on the total weight (100 wt %) of the thermoplastic resin composition. In some embodiments, the thermoplastic resin composition may include the base resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95wt %. Further, according to some embodiments of the present invention, the amount of the base resin can be in a range from about any of the foregoing amounts to about any other of the foregoing amounts.

Next, each component will be described in detail.

(A) Polyphenylene Ether Resin

Examples of the (A) polyphenylene ether resin may include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, a copolymer of poly(2,6-dimethyl-1,4-phenylene)ether and poly(2,3,6-trimethyl-1,4-phenylene)ether, a copolymer of poly(2,6-dimethyl-1,4-phenylene)ether and poly(2,3,6-triethyl-1,4-phenylene)ether, and the like, and combinations thereof. In exemplary embodiments, poly(2,6-dimethyl-1,4-phenylene)ether, or a copolymer of poly(2,6-dimethyl-1,4-phenylene)ether and poly(2,3,6-trimethyl-1,4-phenylene)ether can be used, for example, the (A) polyphenylene ether resin can be poly(2,6-dimethyl-1,4-phenylene)ether.

The degree of polymerization of the polyphenylene ether resin used in preparation of the resin composition is not particularly limited. Taking into account heat stability and workability of the resin composition, the polyphenylene ether resin can have an intrinsic viscosity of about 0.2 dl/g to about 0.8 dl/g as measured in chloroform as a solvent at 25° C.

The (A) polyphenylene ether resin is a part of the base resin. The base resin may include the (A) polyphenylene ether resin in an amount of about 45 wt % to about 90 wt %, for example about 50 wt % to about 75 wt %, and as another example about 60 wt % to about 70 wt %, based on the total weight (100 wt %) of the base resin. In some embodiments, the base resin may include the (A) polyphenylene ether resin in an amount of about 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the polyphenylene ether resin can be in a range from about any of the foregoing amounts to about any other of the foregoing amounts.

When the base resin includes the polyphenylene ether resin in an amount within the above range, the composition can exhibit suitable properties and can have excellent impact resistance.

(B) Aromatic Vinyl-Based Resin

The aromatic vinyl-based resin is added to improve flowability of the resin composition of the present invention.

The aromatic vinyl-based resin may be a polymer of an aromatic vinyl monomer; a copolymer of an aromatic vinyl monomer and another copolymerizable monomer; or a rubber modified aromatic vinyl-based resin which is a polymer of the aromatic vinyl monomer and a rubbery polymer.

Examples of the aromatic vinyl monomer may include without limitation styrene, α-methylstyrene, β-methylstyrene, p-methylstyrene, p-t-butylstyrene, ethylstyrene, and the like, and combinations thereof.

Examples of the other copolymerizable monomer may include without limitation acrylonitrile, acrylic acid, methacrylic acid, maleic anhydride, N-substituted maleimide, and the like, and combinations thereof.

Examples of the rubbery polymer may include without limitation diene rubbers, such as butadiene rubbers, copolymers of butadiene and styrene, acrylonitrile-butadiene rubbers, and the like; saturated rubbers obtained by hydrogenating the diene rubbers, isoprene rubbers, acrylic rubbers and ethylene-propylene-diene monomer (EPDM) terpolymers, and the like, and combinations thereof. Butadiene rubbers, copolymers of butadiene and styrene, isoprene rubbers, alkylacrylate rubbers, and the like can be used in exemplary embodiments.

The rubbery polymer may be present in an amount of about 1 wt % to about 30 wt %, for example about 5 wt % to about 15 wt %, based on the total weight (100 wt %) of the (B) aromatic vinyl-based resin. In some embodiments, the (B) aromatic vinyl-based resin may include the rubbery polymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30wt %. Further, according to some embodiments of the present invention, the amount of the rubbery polymer can be in a range from about any of the foregoing amounts to about any other of the foregoing amounts.

In order to exhibit appropriate physical properties in a blend of the rubber modified aromatic vinyl-based resin and the polyphenylene ether resin, the average particle size of the rubber phase can be about 0.1 μm to about 6.0 μm on the basis of Z-average. In order to exhibit desired physical properties, the average particle size of rubber phase may be about 0.25 μm to about 3.5 μm on the basis of Z-average.

Examples of the (B) aromatic vinyl-based resin may include without limitation polystyrene (PS), high impact polystyrene (HIPS), acrylonitrile-butadiene-styrene copolymer resin (ABS), acrylonitrile-styrene copolymer resin (SAN), acrylonitrile-styrene-acrylate copolymer resin (ASA), and the like. These resins may be used alone or in combination of two or more thereof. In exemplary embodiments, polystyrene (PS) or high impact polystyrene (HIPS) can be used, and these resins can have excellent compatibility with the polyphenylene ether resin.

Methods for preparing the (B) aromatic vinyl-based resin are well known in the art, and the (B) aromatic vinyl-based resin can be commercially available.

In the present invention, the (B) aromatic vinyl-based resin is a part of the base resin. The base resin may include the (B) aromatic vinyl-based resin in an amount of about 10 wt % to about 55 wt %, for example about 25 wt % to about 50 wt %, and as another example about 30 wt % to about 40 wt %, based on the total weight (100 wt %) of the base resin. In some embodiments, the base resin may include the (B) aromatic vinyl-based resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. Further, according to some embodiments of the present invention, the amount of the aromatic vinyl-based resin can be in a range from about any of the foregoing amounts to about any other of the foregoing amounts.

(C) Glass Fibers

The (C) glass fibers comprise (C1) chopped glass fibers and (C2) milled glass fibers. The resin composition can include the (C) glass fibers in an amount of about 5 wt % to about 50 wt %, for example about 15 wt % to about 35 wt %, and as another example about 17 wt % to about 30 wt %, based on the total weight (100 wt %) of the resin composition. In some embodiments, the resin composition may include the (C) glass fibers in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the glass fibers can be in a range from about any of the foregoing amounts to about any other of the foregoing amounts.

When the resin composition includes the glass fibers (C) in an amount within this range, an excellent balance of physical properties such as mechanical strength and flowability can be obtained.

(C1) Chopped Glass Fibers

The (C1) chopped glass fibers are well known in the art, are commercially available, and can be prepared by a typical method in the art. The chopped glass fibers can have a diameter of about 8 μm to about 20 μm and a length of about 1 mm or more, for example, about 1.5 mm to about 15 mm. In exemplary embodiments, chopped glass fibers having a length of about 2 mm to about 6 mm can be used.

The (C1) chopped glass fibers may have various cross sectional shapes, such as a circular shape, elliptical shape, rectangular shape, and the like, depending on the usage of the (C1) chopped glass fibers.

Further, the (C1) chopped glass fibers may be subjected to surface treatment.

The chopped glass fibers can have an aspect ratio of about 1.0 to about 2.0, for example about 1.0 to about 1.3.

(C2) Milled Glass Fibers

The (C2) milled glass fibers are well known in the art, are commercially available, and can be prepared by a typical method. The (C2) milled glass fibers may have a diameter of about 8 μm to about 20 μm and a length of about 1 μm to about 999 μm. In exemplary embodiments, the (C2) milled glass fibers can have a length of about 10 μm to about 100 μm, for example about 30 μm to about 90 μm. Within this range, the resin composition can exhibit excellent properties in terms of flowability, appearance, and dimensional stability.

When typical talc or other inorganic fillers are combined with chopped glass fibers, there is a side effect that the reinforcing effect of the chopped glass fibers is deteriorated. In the present invention, such deterioration in physical properties can be prevented by adding milled glass fibers.

The (C2) milled glass fibers may have various cross sectional shapes such as a circular shape, elliptical shape, and the like, depending on the usage of the milled glass fibers.

In addition, the (C2) milled glass fibers may be subjected to surface treatment.

In one embodiment, the (C) glass fibers can include the the milled glass fibers (C2) in an amount of about 10 wt % to about 95 wt %, for example about 20 wt % to about 65 wt %, and as another example about 25 wt % to about 50 wt %, based on the total weight (100 wt %) of the (C) glass fibers. In some embodiments, the (C) glass fibers can include the milled glass fibers (C2) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the (C2) milled glass fibers can be in a range from about any of the foregoing amounts to about any other of the foregoing amounts.

When the (C) glass fibers include the (C2) milled glass fibers in an amount within this range, the resin composition can have an excellent balance of mechanical strength, flowability and heat resistance.

The ratio of the (C1) chopped glass fibers to the (C2) milled glass fibers, that is, (C1):(C2) can be about 0.6:1 to 3:1, for example about 1:1 to 3:1. Within this range, the resin composition can provide excellent appearance and gloss and can have outstanding flowability.

The present invention may further include one or more additives such as but not limited to flame retardants, plasticizers, coupling agents, heat stabilizers, light stabilizers, inorganic fillers, releasing agents, dispersing agents, anti-dripping agents, weather-proofing stabilizers, and the like. The additives may be used alone or in combination of two or more thereof. The content and sort of the additive may be suitably selected by a person skilled in the art.

In one embodiment, the resin composition may have a flexural modulus of about 40,000 kgf/cm² or more, a flexural strength of about 1,000 kgf/cm² or more at a ⅛ inch thickness in accordance with ASTM D790, a heat distortion temperature (HDT) of about 140° C. or more under a load of 18.56 kgf/cm² in accordance with ASTM D648, and a melt index (MI) of about 12 g/10 min or more in accordance with ASTM D1238 (300° C., 5 kg).

In another embodiment, the reins composition may have a flexural modulus of about 44,000 kgf/cm² to about 65,000 kgf/cm², a flexural strength of about 1,100 kgf/cm² to about 2,500 kgf/cm² at a ⅛ inch thickness in accordance with ASTM D790, a heat distortion temperature (HDT) of about 140° C. to about 165° C. under a load of 18.56 kgf/cm² in accordance with ASTM D648, and a melt index (MI) of about 15 g/10 min to about 35 g/10 min in accordance with ASTM D1238 (300° C., 5 kg).

The resin composition may have a melt index of about 20 g/10 min to about 30 g/10 min in accordance with ASTM D1238 (300° C., 5 kg).

The resin composition may have a gloss at 60° of about 65% or more, for example about 70% to 80% in accordance with ASTM D523.

The present invention also relates to a molded product prepared using the resin composition. The molded product may have a structure in which (C1) chopped glass fibers and (C2) milled glass fibers are dispersed in a base resin including (A) a polyphenylene ether resin and (B) an aromatic vinyl-based resin.

Conventionally, when glass fibers are subjected to extrusion and molding, the glass fibers can encounter cutting or shrinkage. In the case of the (C1) chopped glass fibers, glass fibers having a length of about 2 mm to about 6 mm may be changed to glass fibers having a length of about 0.2 mm to about 6 mm. Milled glass fibers may be formed in the range of not more than about 10% of the content of the chopped glass fibers. Accordingly, in preparation of the resin composition, the ratio of the (C1) chopped fiber glasses to the (C2) milled glass fibers (C1):(C2) is about 0.6:1 to 3:1, for example about 1:1 to 3:1.

The resin composition of the present invention can have an excellent balance of physical properties including mechanical strength, heat resistance, flowability, appearance, dimensional stability, and the like, and thus may be advantageously employed in ignition coils of vehicles.

Next, the present invention will be better appreciated from the following examples and comparative examples. It should be understood that these examples are provided for illustration only and are not to be construed in any way as limiting the scope of the present invention.

Descriptions of details apparent to those skilled in the art will be omitted.

### EXAMPLES

The specifications of components used in in Examples and Comparative Examples are as follows:

(A) Polyphenylene ether resin: NPX 100F manufactured by Mitsubishi Engineering Plastics.

(B1) Aromatic vinyl-based resin: HIPS resin (HR-1360 manufactured by Cheil Industries Inc) is used.

(B2) Aromatic vinyl-based resin: polystyrene resin (HR-2660 manufactured by Cheil Industries Inc) is used.

(C) Glass Fibers

(C1) Chopped glass fibers having a diameter of 13 μm and a length of 3 mm are used.

(C2) Milled glass fibers having a diameter of 13 μm and a length of 100 μm are used.

### Examples 1 to 5

The components are mixed in an amount as listed in Table 1, followed by extrusion at 250° C. to 300° C. using a twin screw extruder having a feed rate of 50 kg/hr, a screw rpm of 250, a diameter of 45Φ nd L/D=36. The resultant is pelletized to prepare specimens for evaluation of physical properties. The physical properties of the specimens are evaluated as follows.

### Comparative Examples 1 to 6

Specimens are prepared in the same manner as in the inventive examples except that the content of each component is changed as shown in Table 1. In Comparative Example 4, a specimen is unable to be prepared since it is impossible to process the composition.

<Evaluation Method>

(1) Appearance: Rectangular plate-shaped specimens having a size of 6 inch×6 inch are subjected to injection molding, followed by visual observation of the presence of flow mark and roughness. Higher scores indicate increasingly poor appearance (1 (best appearance)<2<3<4<5 (worst appearance)).

(2) Gloss (%): Gloss at 60° is measured in accordance with ASTM D523.

(3) Shrinkage (%): Shrinkage is evaluated using ⅛ inch thickness rectangular specimens in accordance with ASTM D 955.

(4) Warpage: Warpage is visually observed using 1/16 inch thickness rectangular specimens. Higher scores indicate increasingly severe distortion (warpage) (1 (lowest distortion)<2<3<4 (severest distortion)).

(5) Flexural strength and flexural modulus: Flexural strength (FS) and flexural modulus (FM) are measured at a rate of 2.8 mm/min in accordance with ASTM D790. ⅛ inch thickness specimens are used and measurement results are given in kgf/cm².

(6) Heat Distortion Temperature (HDT, ° C.): Heat distortion temperature is measured under a load of 18.56 kgf/cm² in accordance with ASTM D648.

(7) Melt Index (MI, g/10 min): Melt index is measured at 300° C. and 5 kg in accordance with ASTM D1238.

Results of measurement are shown in Table 1.

TABLE 1

| | Example | | | | | Comparative Example | | | | | |
|---|---|---|---|---|---|---|---|---|---|---|---|
| | 1 | 2 | 3 | 4 | 5 | 1 | 2 | 3 | 4 | 5 | 6 |
| (A) PPE | 50 | 45 | 40 | 50 | 50 | 50 | 50 | 50 | 80 | 65 | 50 |
| (B1) HIPS | 30 | 35 | 40 | 30 | — | 30 | 30 | 30 | — | 35 | 30 |
| (B2) PS | — | — | — | — | 30 | — | — | — | — | — | — |
| (C1) Chopped | 15 | 15 | 15 | 10 | 15 | 20 | — | 10 | 15 | — | — |
| GF | | | | | | | | | | | |
| (C2) Milled GF | 5 | 5 | 5 | 10 | 5 | — | 20 | — | 5 | — | — |
| Talc | | | | | | — | — | 10 | — | — | 20 |
| Appearance | 2 | 2 | 2 | 1 | 3 | 5 | 1 | 4 | Processing | 1 | 2 |
| Gloss | 70 | 72 | 73 | 77 | 74 | 60 | 82 | 59 | impossible | 86 | 60 |
| Shrinkage | | | | | | | | | | | |
| flow | 0.22 | 0.25 | 0.26 | 0.24 | 0.21 | 0.21 | 0.25 | 0.23 | | 0.18 | 0.24 |
| cross-flow | 0.36 | 0.37 | 0.37 | 0.31 | 0.36 | 0.46 | 0.29 | 0.32 | | 0.2 | 0.31 |
| Warpage | 2 | 2 | 2 | 1 | 2 | 3 | 1 | 1 | | 1 | 1 |
| FS | 1,500 | 1,300 | 1,000 | 1,100 | 1,400 | 1,800 | 1,000 | 900 | | 800 | 1,000 |
| FM | 52,000 | 48,000 | 44,000 | 45,000 | 50,000 | 58,000 | 37,000 | 38,000 | | 22,000 | 39,000 |
| HDT | 150 | 144 | 140 | 147 | 152 | 155 | 146 | 149 | | 141 | 144 |
| MI | 20 | 26 | 30 | 24 | 22 | 14 | 29 | 24 | | 41 | 18 |

As shown in Table 1, Examples 1 to 5 exhibit excellent appearance, gloss, dimensional stability, heat resistance and flowability, as compared with Comparative Examples. Specifically, the composition of the inventive examples exhibit excellent flexural strength and flexural modulus while ensuring excellent appearance and gloss. The specimen of Comparative Example 4 includes (C1) chopped glass fiber and (C2) milled glass fibers, but their processing is impossible in the absence of the aromatic vinyl-based resin.

The thermoplastic resin composition of the present invention is capable of preventing flowability reduction, which is a drawback of polyphenylene ether resin as well as limitation of GF reinforcing materials, while achieving suppression of post-molding distortion, and good appearance. The thermoplastic resin composition of the present invention can have excellent properties in terms of dimensional stability, mechanical strength and heat resistance, and can be suitable for materials for ignition coils of vehicles.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition comprising:
a base resin comprising (A) a polyphenylene ether resin and (B) an aromatic vinyl-based resin; and
(C) glass fibers,
wherein the (C) glass fibers comprise (C1) chopped glass fibers and (C2) milled glass fibers.

2. The thermoplastic resin composition according to claim 1, wherein the (C1) chopped glass fibers have a length of about 1 mm or more.

3. The thermoplastic resin composition according to claim 2, wherein the (C2) milled glass fibers have a length of about 1 μm to about 999 μm.

4. The thermoplastic resin composition according to claim 2, wherein the (C2) milled glass fibers have a length of about 10 μm to about 100 μm.

5. The thermoplastic resin composition according to claim 1, wherein the milled glass fiber is present in an amount of about 10 wt % to about 95 wt % based on the total weight of the (C) glass fibers.

6. The thermoplastic resin composition according to claim 1, wherein the (C) glass fibers are present in an amount of about 5 wt % to about 50 wt % based on the total weight of the resin composition.

7. The thermoplastic resin composition according to claim 1, wherein the base resin comprises about 45 wt % to about 90 wt % of the (A) polyphenylene ether resin.

8. The thermoplastic resin composition according to claim 1, wherein the (B) aromatic vinyl-based resin comprises polystyrene (PS), high impact polystyrene (HIPS), acrylonitrile-butadiene-styrene copolymer resin (ABS), acrylonitrile-styrene copolymer resin (SAN), acrylonitrile-styrene-acrylate copolymer resin (ASA), or a combination thereof.

9. The thermoplastic resin composition according to claim 1, further comprising at least one additive selected from the group consisting of flame retardants, plasticizers, coupling agents, heat stabilizers, light stabilizers, inorganic fillers, releasing agents, dispersing agents, anti-dripping agents, weather-proofing stabilizers, and combinations thereof.

10. The thermoplastic resin composition according to claim 1, wherein the composition has a flexural modulus of about 40,000 kgf/cm² or more, a flexural strength of about 1,000 kgf/cm² or more at a ⅛ inch thickness in accordance with ASTM D790, a heat distortion temperature (HDT) of about 140° C. or more under a load of 18.56 kgf/cm² in accordance with ASTM D648, and a melt index (MI) of about 12 g/10 min or more in accordance with ASTM D1238 (300° C., 5 kg).

11. A molded product produced from the thermoplastic resin composition according to claim 1, wherein the molded product has a structure in which the (C1) chopped glass fibers and the (C2) milled glass fibers are dispersed in the base resin comprising the (A) polyphenylene ether resin and the (B) aromatic vinyl-based resin.

12. The molded product according to claim 11, wherein the molded product is an ignition coil of vehicles.
